(19) United States
(12) Patent Application Publication
(10) Pub. No.: US 2025/0350616 A1
(43) Pub. Date: Nov. 13, 2025

(54) SYSTEMS AND METHODS FOR ANALYSING TRANSFER DATA IN DIGITAL ENVIRONMENTS

(71) Applicant: Adeia Guides Inc., San Jose, CA (US)

(72) Inventors: Markus Rautell, Kerava (FI); Pekka Koskela, Oulu (FI); Anni Karinsalo, Oulu (FI); Dhananjay Lal, Englewood, CO (US)

(21) Appl. No.: 18/662,288

(22) Filed: May 13, 2024

(51) Int. Cl. H04L 9/40; A63F 13/71; A63F 13/75; A63F 13/79

(52) U.S. Cl. CPC H04L 63/1425; A63F 13/71; A63F 13/75; A63F 13/79

(57) ABSTRACT

The present disclosure relates to systems and methods for analyzing transfer data within digital environments and to improve network security through user identification mechanisms. This disclosure focuses on techniques for identifying and evaluating transfers patterns between user accounts, which may involve intermediary accounts. The systems and methods detailed herein aim to identify irregular transfer patterns by analyzing transfer data and implementing unique user identification processes.

### BACKGROUND

The present disclosure pertains to systems and methods for analyzing transfer data within digital environments, such as gaming environments, and improving network security by implementing unique user identification mechanisms. Specifically, but not exclusively, the present disclosure is concerned with systems and methods for identifying and evaluating a series of transfers between user accounts, including those facilitated by intermediary accounts.

### SUMMARY

In digital environments (e.g., gaming environments), it is desirable to efficiently manage and analyze transfer data between user accounts, reflecting a range of user interactions, such as the exchange of in-game assets and/or the transfer of in-game currency. For instance, gamers may engage in complex transfer chains that may span multiple accounts (e.g., in-game transfers which take place through several intermediaries before reaching the final recipient) or span multiple transfers (e.g., multiple transfers originating from one user account).

In some cases, these transfers may be illegitimate, violating the rules of the game or representing misuse of the gaming environment's terms of use. For example, multiple players may coordinate in-game transfers to fix matches or outcomes. It is desirable to identify these transfers, distinguishing between legitimate interactions and potential misuses.

In some examples, digital gaming platforms within digital gaming environments face challenges in coordinating their efforts to monitor and regulate user activities due to the lack of a unified system for tracking and authenticating user accounts across different digital gaming platforms. It is desirable to accurately identify and/or authenticate user accounts engaging in transfers within digital gaming environments.

For example, in digital gaming environments, where the volume and velocity of data transfers are substantial, conserving computer resources and increasing efficiency are of paramount importance. It is desirable to optimize these systems to reduce unnecessary data transmission, which in turn conserves bandwidth and reduces server load. By streamlining the data transfer process, digital gaming platforms can achieve a more responsive and agile environment that enhances the user experience. To this end, it is desirable to implement methods and systems capable of identifying and flagging only those transfers that exhibit characteristics of illegitimate activity, rather than subjecting all transfers to intensive scrutiny. Such selective monitoring can decrease the quantity of data that needs to be processed and stored, freeing up computational resources and reducing costs associated with data management.

In another example, improving operational efficiency within distributed systems presents significant challenges, particularly when it comes to authenticating and establishing secure connections commonly between disparate systems. The complexity of these operations often results in extensive data transfer, which can impede system performance and responsiveness. It is therefore desirable to streamline the authentication process to minimize the volume of communication required for user account verification.

To address these challenges, the present disclosure provides systems and methods for analyzing and/or managing transfer data within a digital gaming environment. For example, the present disclosure provides techniques for analyzing transfers between a first and second user account, and calculating an expected transfer value of the series of transfers between the first user account and the second user account based on a first probability of an event outcome in the digital gaming environment. Techniques provided herein may include encryption-based identification of user accounts for tracking and authenticating user accounts across different digital gaming platforms.

In some examples of the disclosure, the described systems and methods for managing and analyzing transfer data within digital gaming environments can be extended to media consumption and e-commerce environments. For instance, in media platforms, the system may analyze content sharing and recommendations, distinguishing between authentic user engagement and potential misuse of the platform's features. Similarly, in e-commerce, the approach may enhance the security and integrity of transfers by identifying and flagging irregularities in purchase patterns or seller behavior, leveraging encryption-based identification for user authentication.

In some examples, upon flagging suspicious activities, systems and methods are implemented to perform a variety of actions. These actions may include freezing or blocking the implicated user accounts to prevent further unauthorized activities. For transfers identified as irregular or fraudulent, the system may reverse or freeze these operations, preserving the assets and maintaining the trust of legitimate users. Furthermore, account holders, platform administrators, or relevant authorities may be alerted about the suspicious activity, enabling timely intervention. Additionally, accounts flagged for suspicious activities may be subjected to increased review and scrutiny.

According to aspects of the present disclosure, systems and methods are provided for analyzing transfer data in a digital gaming environment. Example systems and methods disclosed herein comprise a database (e.g., a centralized data store managed by a digital gaming platform within the digital gaming environment) and processing circuitry (e.g., a dedicated server, cloud-based instance, or specialized hardware component). In some examples the processing circuitry retrieves transfer data (e.g., records of in-game transfers between user accounts) from the database.

In some examples a series of transfers between a first user account and a second user account within the digital gaming environment is identified (e.g., a series of in-game transfers, or the exchange of items). For example, an expected transfer value e.g. a mean value, of the series is calculated based on a probability of an event outcome (e.g., a probability based on historical transfer behaviors between accounts, win probabilities of gaming events, or outcomes of similar events).

For example, the processing circuitry may determine the first probability by calculating a second probability reflecting the potential gain for the first user account offset by a loss to the second user account, and a third probability, assessing the potential gain for the second account against losses from the first user account. In some examples, the second and third probabilities may be based on historical transfer data within the gaming environment, incorporating variables such as past event outcomes and established player transfer patterns. In some examples, the processing circuitry integrates these calculated probabilities to adjust the expected value of each transfer in the series (e.g., by increasing or decreasing the expected transfer value of each transfer in the series of transfers).

In some examples, actual transfer values are compared against the calculated expected transfer value. In some examples, upon determining a deviation between actual and expected transfer values exceeding a threshold (e.g., a threshold based on a value and/or frequency of one or more transfers in the series), the series of transfers is flagged (e.g., tagged metadata). In some examples, details of the flagged transfers and participating accounts (e.g., timestamps, specific transfer amounts) are communicated back to the database for further analysis (e.g., sent to the digital gaming platform).

In some examples, details of the flagged transfers and participating accounts are communicated between multiple databases associated with the digital gaming environment. For example, the processing circuitry may send details of the flagged transfers and participating accounts to other game servers or platforms. In some examples, the system may leverage distributed ledger technologies. For example, the processing circuitry may store the details of the flagged transfers and participating accounts into a transfer record. This record may then broadcast or communicated to other game servers or platforms which receive and append this record to their copy of the series of transfers.

In some examples, the processing circuitry is configured to analyze interactions involving transfers that include one or more intermediary accounts, allowing for the identification and analysis of more complex transfer chains that might be used to obscure the origin and destination of in-game assets (e.g., using colluding accounts as intermediaries to make in-game transfers).

In some examples, in response to deviations between actual and expected transfer values exceeding a second threshold (e.g., a second threshold attributed to intermediary accounts in the series of transfers), the processing circuitry may analyze interactions among intermediary accounts in the series of transfers, which include in-game messages. For example, the processing circuitry may assess the frequency, timing, and content of messages exchanged between accounts (e.g., analyzing message timestamps in correlation with transfer events, evaluating message content for indications of non-game-related coordination).

In some examples, the processing circuitry identifies transfers that do not directly contribute to gameplay or the digital economy but could indicate misuse of the digital gaming platform. For instance, transfers that circle back to the initiating account (e.g., first user account) without engaging in any gameplay-related event (e.g., depositing an in-game currency into an account followed by an immediate withdrawal) are flagged.

In some examples, the processing circuitry applies cryptographic techniques to user information (e.g., when creating a new user account for a digital gaming platform), generating unique identifiers. The processing circuitry may hash and encrypt user identity information with deterministic algorithms, ensuring each user account across the digital gaming platform can be uniquely identified (e.g., creating a hash-based ID for account verification purposes).

In some examples, when a user's hash-based identifier is found to exist in the database, the processing circuitry modifies this identifier by appending an index, generating a new, unique identifier. This iterative indexing and verification process (e.g., generating indexed hash-based identifiers until a unique one is found) helps to prevent identity duplication.

In some examples, to ensure the integrity of user interactions, the processing circuitry compares user information across accounts, looking for matching identification data (e.g., device IDs, IP addresses, location information). If a threshold number of identifiers match between two accounts, suggesting potential misuse (e.g., one player operating multiple accounts to circumvent game rules), this information is flagged and communicated back to the database for further action.

According to another aspect of the present disclosure, systems and methods are provided for improving network security by implementing unique user identification mechanisms. In some examples, the system includes processing circuitry configured to execute several operations within a digital gaming environment. Upon receiving user information for the first user account, the processing circuitry performs a hashing process on the user information to generate a hash-based identifier. In some examples, the processing circuitry encrypts the user information to produce an encrypted identifier. Subsequently, the processing circuitry determines if the hash-based identifier already exists in the database. In cases where the hash-based identifier does not exist in the database, the processing circuitry stores the encrypted identifier for the first user account in the database.

In some examples, the system includes processing circuitry configured to modify the hash-based identifier if it already exists in the database. For instance, upon determining that the hash-based identifier exists in the database, the processing circuitry concatenates it with an index to produce an indexed hash-based identifier.

In some examples, the system comprises processing circuitry configured to compare user information between the first user account and the second user account. This user information may consist of or include multiple forms of identification. The processing circuitry determines if a threshold number of these multiple forms of identification matches between the first user account and the second user account. Upon determining that the threshold number of multiple forms of identification matches, the processing circuitry communicates details of the first user account and the second user account back to the database.

### BRIEF DESCRIPTION OF THE DRAWINGS

The present disclosure, in accordance with one or more various examples, is described in detail with reference to the following Figures. The drawings are provided for purposes of illustration only and merely depict typical examples. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an example system for analyzing transfer data in a digital gaming environment, in accordance with some examples of the disclosure;

FIGS. 2A-2B show illustrative devices, systems, servers, and related hardware for analyzing transfer data in a digital gaming environment, in accordance with some examples of the disclosure;

FIG. 3 depicts an example of transfer data comprising a series of transfers between a first user account and a second user account, in accordance with some examples of this disclosure;

FIGS. 4A-4B present example scenarios comprising a series of transfers between the first user account and the second user account via one more other user accounts, in accordance with some examples of this disclosure;

FIG. 5 presents an example scenario showing an interaction between one or more other user accounts in the series of transfers, in accordance with some examples of this disclosure;

FIG. 6 illustrates an example interaction between user accounts within the digital gaming environment, in accordance with some examples of this disclosure;

FIGS. 7A-7C depict flowcharts representing a process for analyzing transfer data in a digital gaming environment, in accordance with some examples of this disclosure;

FIGS. 8A-8C shows example systems and processes for creating and managing user accounts, in accordance with some examples of the disclosure; and

FIGS. 9A-9B present example scenarios illustrating different types of transfer activity, in accordance with some examples of the disclosure.

### DETAILED DESCRIPTION

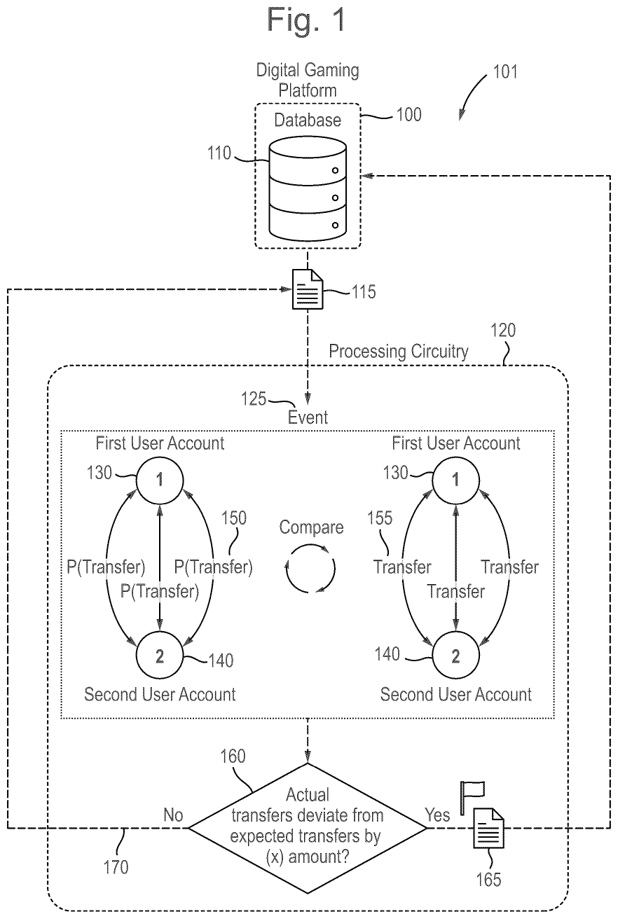

FIG. 1 illustrates a system for analyzing transfer data within a digital gaming environment, comprising a digital gaming platform 100, a database 110, and processing circuitry 120. The digital gaming environment is conceptualized as a virtual ecosystem where user accounts engage with games hosted on servers (e.g., digital gaming platform 100) and participate in various in-game activities, including transfers of in-game assets. The database 110 may act as a repository for storing detailed records of transfers, including metadata that provides context for each transfer. The processing circuitry 120, analyzes transfer data 115, assessing transfer patterns and calculating an expected transfer value (e.g., a mean value) based on e.g., a probability distribution function of event outcomes within the gaming environment. When a deviation between the expected transfer value 150 and actual transfer values 155 exceeds a threshold, the processing circuitry 120 flags the transfer data 165 for further investigation. The flagged transfer data is then communicated back to the database 110.

For example, flagged transfer data 165 may be communicated back to the digital gaming platform. In some examples, flagged transfer data 165 is communicated to a database of a different digital platform or to another database altogether. The flagging process may involve communicating alerts or notifications. The flagging process may incorporate detailed information about the flagged transfer, including the involved user accounts, the nature of the deviation from expected values, and any relevant timestamps or transfer IDs.

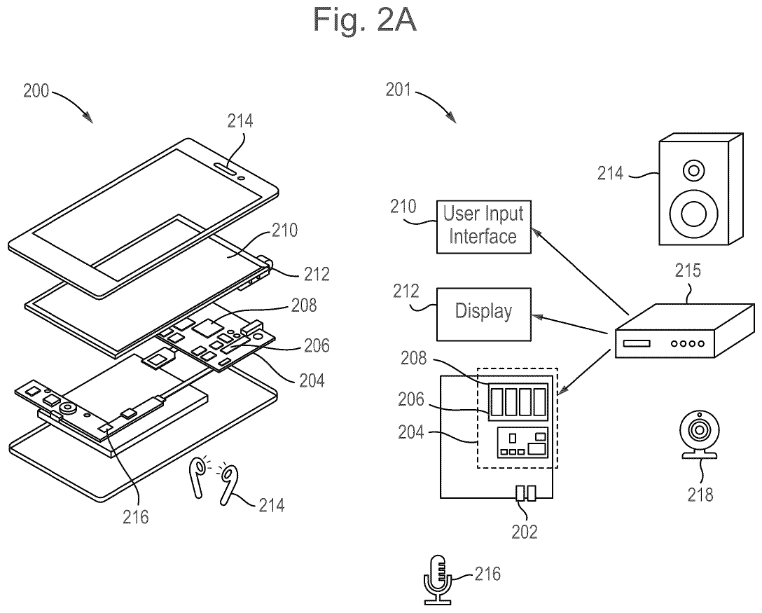

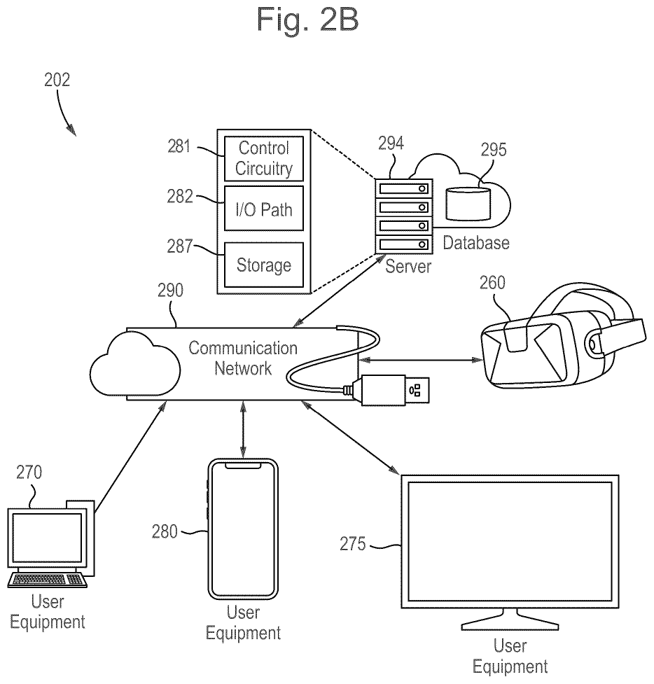

In some examples of the disclosure, the digital gaming environment is a virtual ecosystem where user accounts interact with games, e.g., user accounts logged into a gaming application, e.g., at a user device 270, 275 or 280, as shown in FIGS. 2A and 2B. User accounts may engage in gameplay activities, and participate in various in-game transfers. While the example shown in FIG. 1 refers to system 101, it will be appreciated that the illustrative processes disclosed herein may be implemented, in whole or in part, on system 101, system 200, system 800 and/or any other appropriately configured system architecture.

In an example shown in FIG. 1, processing circuitry 120, retrieves transfer data 115, stored in a database 110, which is integrated within a digital gaming platform 100. The transfer data 115, comprises a series of transfers between a first user account 130, and a second user account 140.

The processing circuitry 120, calculates and expected transfer value 150, of the series of transfers between the first user account and the second user account. In some examples, the calculation comprises an algorithmic process that assesses each transfer against a set of criteria to determine its conformity to expected patterns. For example, the algorithm may consider the historical transfer patterns between user accounts, the frequency and timing of transfers in relation to gaming events, and the comparative analysis of similar account interactions within the broader gaming community. In some examples, the processing circuitry 120, assigns a probability score to each transfer, indicating the likelihood that it aligns with legitimate gameplay activities versus potential exploitation or manipulation of the game's economic system.

The calculated expected transfer value 150, is compared with actual transfer values 155, of each transfer in the series of transfers between the first user account and the second user account. In some examples, the processing circuitry 120, compares an expected transfer value with its actual counterpart. In some examples, the processing circuitry 120, compares the overall expected transfer value with a corresponding overall transfer amount.

In some examples of the disclosure, upon detecting a deviation between an expected and actual transfer values that exceed a threshold 160, the processing circuitry 120, flags the transfer data 165 for further investigation. In some examples, the flagged transfer data 165, is communicated back to the database 110. In some examples, the flagged transfer data 165, includes information about the transfers and the accounts involved. The flagged transfer data 160, may also include metadata concerning the specific in-game events that precipitated the transfers, or metadata concerning player interactions during the event, such as messages exchanged, decisions made that could influence the outcome, or any anomalies in player behavior that deviate from expected patterns.

In some examples, in response to determining that a deviation between an expected and actual transfer values does not exceed a threshold, the processing circuitry 120, resumes its monitoring activities 170, continuing to analyze subsequent transfer data retrieved from database 110.

In some examples, transfer data 115, is linked to a gaming event 125, e.g., an event in which a winning account or participant receives a transfer from the collective contributions of another account or participant. A gaming event may cause the processing circuitry 120 to initiate analysis of one or more predefined rules and/or outcomes of the gaming event, e.g., based on the specific rules and possible outcomes of the gaming event. In some examples, processing circuitry 120, applies an algorithm to assess whether the volume, frequency, and pattern of transfers align with expected outcomes based on past scenarios of the same or similar event. For example, processing circuitry 120, might compare the transfer data 115, against similar gaming events across the digital gaming platform to identify discrepancies or anomalies, or a pattern of transfers that deviates from historical norms.

In some examples of the disclosure, the digital gaming platform 100 (e.g., a game which is hosted on server 294), facilitates the engagement of user accounts with various gaming activities and their associated transfers. The digital gaming platform 100, may, for example, host gaming events e.g., a race or a competitive match, manage player interactions, and oversee the transfer of in-game assets between user accounts. In some examples, the digital gaming platform 100, is configured to allow for in-game communication, e.g., messaging between user accounts.

Additionally, in some examples of the disclosure, the digital gaming platform 100 includes betting mechanisms within gaming activities. This involves facilitating and managing bets placed by user accounts on the outcomes of hosted gaming events.

In some examples, the digital gaming platform 100, may be part of a larger ecosystem associated with a digital gaming environment, wherein multiple digital gaming platforms exist and interact within a unified network or framework, e.g., communicatively linked to one another via communication network 290.

In some examples, the digital gaming platform is configured to specialize in different genres or types of gameplay, e.g., car racing or board games. Each digital gaming platform 100 may cater to specific segments of the gaming community while still being part of the overarching digital gaming environment.

In some examples, a user account associated with one digital gaming platform 100, is interoperable between other digital gaming platforms. For example in-game assets, and player achievements associated with a user account may be recognized or transferred across different platforms, e.g., a user account on one platform might be linked to an associated profile on other digital gaming platforms.

In some examples, the database 110 (e.g., 295), acts as a repository for storing transfer data 115, which may include records of transfers between user accounts. For example, a series of in-game transfers from a first user account 130, to a second user account 140. The database 110, may be configured to store a range of metadata pertaining to transfers for user accounts, including, but not limited to, the quantity of in-game assets transferred, the timestamps of each transfer, and any associated metadata that may provide context for the transfer (e.g., the reason for the transfer, such as a trade, a reward for an in-game achievement, or a gift).

In some examples, database 110, may be configured as part of the digital gaming platform 100, e.g., embedded within the same infrastructure that supports the operation of the digital gaming platform 100, such as database 295 depicted in FIG. 2B. In some examples, database 110, may exist separately, e.g. within a different infrastructure to that of the digital gaming platform 100. In some examples, the database storage may be local, e.g. residing on physical servers associated with the digital gaming platform 100, or cloud-based, e.g., utilizing remote storage services.

In some examples, the processing circuitry 120, is part of a circuit board that includes processing circuitry, control circuitry and input/output circuitry, e.g., as described in FIG. 2A.

Processing circuitry 120 may be part of a cloud computing network, e.g., operating within a distributed system where computational tasks are performed on a network of remote servers hosted on the internet. In some examples, the processing circuitry 120, is implemented as a dedicated server or a set of servers within a data center, equipped with CPUs and GPUs. In some examples, processing circuitry 120, is embedded within the infrastructure of the digital gaming platform e.g., as dedicated hardware. In some examples, the processing circuitry is integrated directly within the user device, such as a mobile device, console, or PC (e.g., as shown in user device 200).

The digital gaming platform 100, database 110, and processing circuitry 120, may operate in a manner analogous to the systems and components depicted in FIGS. 2A and 2B. FIGS. 2A and 2B illustrate the integration and functionality of various devices, systems, servers, and hardware for managing and delivering content within a digital gaming environment. For example, FIGS. 2A and 2B show generalized examples of user devices, which may include smartphones, tablets, and other devices capable of engaging in a digital gaming environment. In another example, FIG. 2B provides details on the communication network and the connections and interactions between user devices and servers e.g., servers associated within the digital gaming environment.

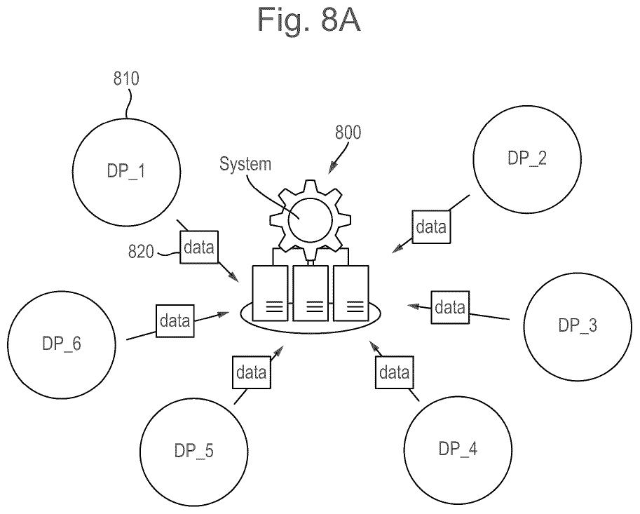

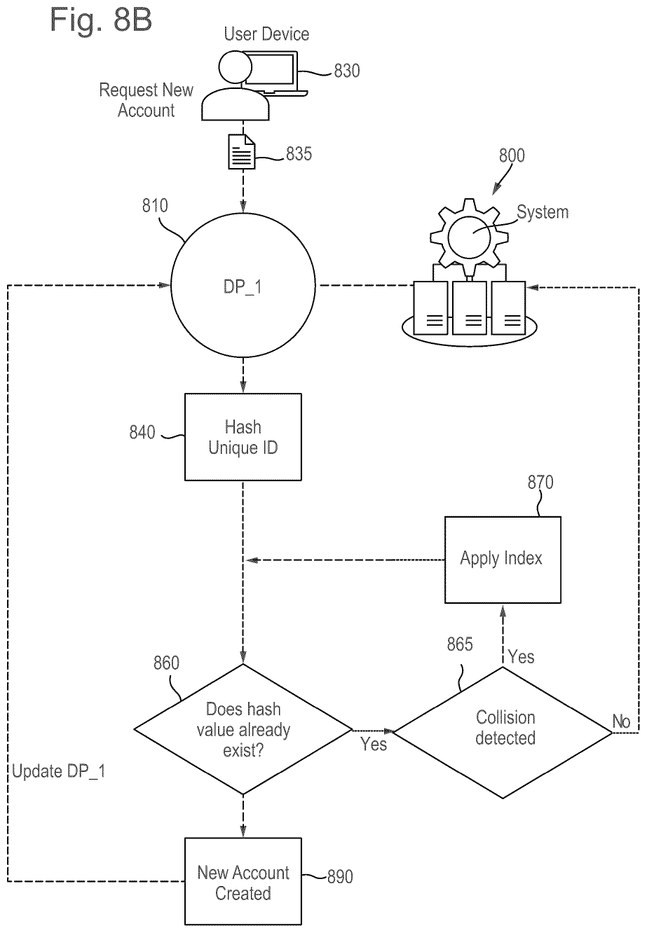

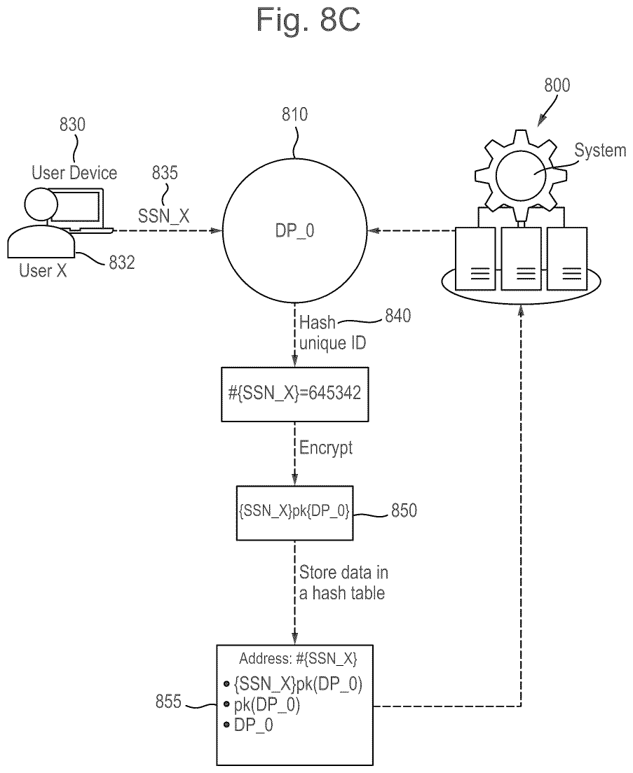

FIGS. 2A-2B describe illustrative devices, systems, servers, and related hardware analyzing transfer data in a digital gaming environment, in accordance with some embodiments of the present disclosure. FIG. 2A shows generalized embodiments of illustrative user device 200 and 201, which may correspond to, e.g., user device 830 of FIGS. 8A-8C. For example, user device 200 may be a smartphone device, a tablet, a near-eye display device, an XR device, or any other suitable device capable of participating in a digital gaming environment, e.g., locally or over a communication network. In another example, user device 201 may be a user television equipment system or PC. User device 201 may include computing device 215. Computing device 215 may be communicatively connected to microphone 216, audio output equipment 214 (e.g., speaker or headphones), and display 212. In some embodiments, microphone 216 may receive audio corresponding to a voice of a user associated with a user account within the digital gaming environment. In some embodiments, display 212 may be a television display or a computer display. In some embodiments, computing device 215 may be communicatively connected to user input interface 210. In some embodiments, user input interface 210 may be a remote-control device. Computing device 215 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user devices are discussed below in connection with FIG. 2B. In some embodiments, device 200 may comprise any suitable number of sensors (e.g., gyroscope or gyrometer, or accelerometer, etc.), and/or a GPS module (e.g., in communication with one or more servers and/or cell towers and/or satellites) to ascertain a location of device 200. In some embodiments, device 200 comprises a rechargeable battery that is configured to provide power to the components of the device.

Each one of user device 200 and user device 201 may receive data and/or content and data via input/output (I/O) path 282. I/O path 282 may provide content (e.g., content pertaining to digital gaming environment) and data to control circuitry 204, which may comprise processing circuitry 206 and storage 208. Control circuitry 204 may be used to send and receive commands, requests, and other suitable data using I/O path 282, which may comprise I/O circuitry. I/O path 282 may connect control circuitry 204 (and specifically processing circuitry 206) to one or more communications paths (described below). I/O functions may be provided by one or more of these communications paths, but are shown as a single path in FIG. 2A to avoid overcomplicating the drawing. While computing device 215 is shown in FIG. 2A for illustration, any suitable computing device having processing circuitry, control circuitry, and storage may be used in accordance with the present disclosure. For example, computing device 215 may be replaced by, or complemented by, a personal computer (e.g., a notebook, a laptop, a desktop), a smartphone (e.g., device 200), an XR device, a tablet, a network-based server hosting a user-accessible client device, a non-user-owned device, any other suitable device, or any combination thereof.

Control circuitry 204 may be based on any suitable control circuitry such as processing circuitry 206. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing circuitry, for example, multiple of the same type of processing circuitry (e.g., two Intel Core i7 processors) or multiple different processors (e.g., an Intel Core i6 processor and an Intel Core i7 processor). In some embodiments, control circuitry 204 executes instructions for the gaming application stored in memory (e.g., storage 208). Specifically, control circuitry 204 may be instructed by the gaming application to perform the functions discussed above and below. In some implementations, processing or actions performed by control circuitry 204 may be based on instructions received from the gaming application.

In client/server-based embodiments, control circuitry 204 may include communications circuitry suitable for communicating with a server or other networks or servers. The gaming application may be a stand-alone application implemented on a device or a server. The gaming application may be implemented as software or a set of executable instructions. The instructions for performing any of the embodiments discussed herein of the gaming application may be encoded on non-transitory computer-readable media (e.g., a hard drive, random-access memory on a DRAM integrated circuit, read-only memory on a BLU-RAY disk, etc.). For example, in FIG. 2A, the instructions may be stored in storage 208, and executed by control circuitry 204 of a device 200.

In some embodiments, the gaming application may be a client/server application where only the client application resides on device 200, and a server application resides on an external server (e.g., server 294). For example, the gaming application may be implemented partially as a client application on control circuitry 204 of device 200 and partially on server 294 as a server application running on control circuitry 281. Server 294 may be a part of a local area network with one or more of devices 200, 201 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 294 and/or an edge computing device), referred to as “the cloud.” Device 200 may be a cloud client that relies on the cloud computing capabilities from server 294 to facilitate engagement options in a digital gaming environment.

Control circuitry 204 may include communications circuitry suitable for communicating with a server, edge computing systems and devices, a table or database server, or other networks or servers. The instructions for carrying out the above-mentioned functionality may be stored on server 294. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the internet or any other suitable communication networks or paths (which is described in more detail in connection with FIG. 2B). In addition, communications circuitry may include circuitry that enables peer-to-peer communication of user device, or communication of user device in locations remote from each other (described in more detail below).

Memory may be an electronic storage device provided as storage 208 that is part of control circuitry 204. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 208 may be used to store various types of content described herein as well as gaming application data described above. Nonvolatile memory may also be used (e.g., to launch a boot-up routine and other instructions). Cloud-based storage, described in relation to FIG. 2A, may be used to supplement storage 208 or instead of storage 208.

Control circuitry 204 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 204 may also include scaler circuitry for upconverting and down converting content into the preferred output format of user device 200. Control circuitry 204 may also include digital-to-analog converter circuitry and analog-to-digital converter circuitry for converting between digital and analog signals. The tuning and encoding circuitry may be used by user device 200, 201 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 208 is provided as a separate device from user device 200, the tuning and encoding circuitry (including multiple tuners) may be associated with storage 208.

Control circuitry 204 may receive instruction from a user by way of user input interface 210. User input interface 210 may be any suitable user interface, such as a remote control, mouse, trackball, keypad, keyboard, touch screen, touchpad, stylus input, joystick, voice recognition interface, or other user input interfaces. Display 212 may be provided as a stand-alone device or integrated with other elements of each one of user device 200 and user device 201. For example, display 212 may be a touchscreen or touch-sensitive display. In such circumstances, user input interface 210 may be integrated with or combined with display 212. In some embodiments, user input interface 210 includes a remote-control device having one or more microphones, buttons, keypads, any other components configured to receive user input or combinations thereof. For example, user input interface 210 may include a handheld remote-control device having an alphanumeric keypad and option buttons. In a further example, user input interface 210 may include a handheld remote-control device having a microphone and control circuitry configured to receive and identify voice commands and transmit information to set-top box 215.

Audio output equipment 214 may be integrated with or combined with display 212. Display 212 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 212. Audio output equipment 214 may be provided as integrated with other elements of each one of device 200 and device 201 or may be stand-alone units. An audio component of videos and other content displayed on display 212 may be played through speakers (or headphones) of audio output equipment 214. In some embodiments, audio may be distributed to a receiver (not shown), which processes and outputs the audio via speakers of audio output equipment 214. There may be a separate microphone 216 or audio output equipment 214 may include a microphone configured to receive audio input such as voice commands or speech. For example, a user may speak letters or words that are received by the microphone and converted to text by control circuitry 204. In a further example, a user may voice commands that are received by a microphone and recognized by control circuitry 204. Camera 218 may be any suitable video camera integrated with the equipment or externally connected. Camera 218 may be a digital camera comprising a charge-coupled device (CCD) and/or a complementary metal-oxide semiconductor (CMOS) image sensor. Camera 218 may be an analog camera that converts to digital images via a video card.

The gaming application may be implemented using any suitable architecture. For example, it may be a stand-alone application wholly implemented on each one of user device 200 and user device 201. In such an approach, instructions of the application may be stored locally (e.g., in storage 208), and data for use by the application is downloaded on a periodic basis (e.g., from an out-of-band feed, from an internet resource, or using another suitable approach). Control circuitry 204 may retrieve instructions of the application from storage 208 and process the instructions to provide video conferencing functionality and generate any of the displays discussed herein. Based on the processed instructions, control circuitry 204 may determine what action to perform when input is received from user input interface 210. For example, movement of a cursor on a display up/down may be indicated by the processed instructions when user input interface 210 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 204 may allow a user to provide user profile information or may automatically compile user profile information. For example, control circuitry 204 may access and monitor network data, video data, audio data, processing data, participation data from a conference participant profile. Control circuitry 204 may obtain all or part of other user profiles that are related to a particular user (e.g., via social media networks), and/or obtain information about the user from other sources that control circuitry 204 may access. As a result, a user can be provided with a unified experience across the user's different devices.

As shown in FIG. 2B, user device 270, 280, 275, 260 (which may correspond to, e.g., e.g., user device 830 of FIGS. 8A-8C, may be coupled to communication network 290. Communication network 290 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 290) may separately or together include one or more communications paths, such as a satellite path, a fiber-optic path, a cable path, a path that supports internet communications, or any other suitable wired or wireless communications path or combination of such paths. Communications with the client devices may be provided by one or more of these communications paths but are shown as a single path in FIG. 2B to avoid overcomplicating the drawing.

Although communications paths are not drawn between user devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user device may also communicate with each other directly through an indirect path via communication network290.

In some embodiments, server 294 may include control circuitry 281 and storage 287 (e.g., RAM, ROM, Hard Disk, Removable Disk, etc.). Storage 287 may store one or more databases. Server 294 may also include an I/O path 282. I/O path 412 may provide video conferencing data, device information, or other data, over a local area network (LAN) or wide area network (WAN), and/or other content and data to control circuitry 281, which may include processing circuitry, and storage 287. Control circuitry 281 may be used to send and receive commands, requests, and other suitable data using I/O path 282, which may comprise I/O circuitry. I/O path 282 may connect control circuitry 281 (and specifically control circuitry) to one or more communications paths.

Control circuitry 281 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 411 may be distributed across multiple separate processors or processing circuitry, for example, multiple of the same type of processing circuitry (e.g., two Intel Core i7 processors) or multiple different processors (e.g., an Intel Core i6 processor and an Intel Core i7 processor). In some embodiments, control circuitry 281 executes instructions for an emulation system application stored in memory (e.g., the storage 287).

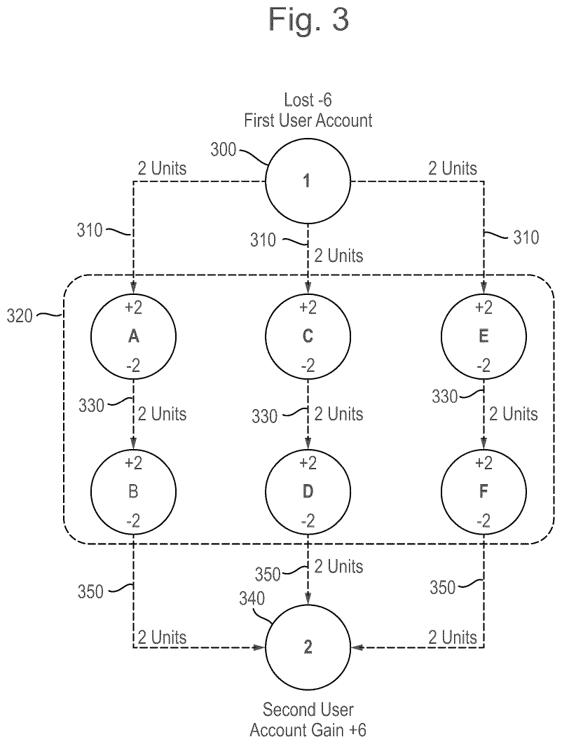

FIG. 3 presents an example flow of transfers between a first user account 300, and a second user account 340, within a digital gaming environment. A series of transfers 310, 330 and 350, are made between two user accounts through a network of intermediary accounts 320. In the example depicted in FIG. 3, the term “unit” is used to represent a unit of value per transfer. The nature of these units is flexible and may encompass a wide range of assets exchangeable within the game. For example, a transfer may include in-game currencies, points, items, or other forms of value which can be tied to the outcome of a gaming event.

In some embodiments, a gaming event is any event which provides an opportunity for participating accounts to compete for a potential gain, loss, or redistribution of assets held or valued within the digital gaming environment e.g., a competitive card game, first-person shooter, or another genre. In some approaches, a participating account of a gaming event is required to commit resources such as in-game currency, items, or other quantifiable assets as a prerequisite for entry.

In some examples, any two accounts can be designated as a first and second user account. Either one or both accounts may engage in transfer activity which may include a plurality of transfers either directly between the two accounts or through a network of intermediary accounts.

Accordingly, the transfer of units visualized in the example of FIG. 3 symbolize portions of the first user account's initial commitment to the gaming event. The flow of these units away from the first account and through intermediary accounts suggests a redistribution of the initial resources. In some examples, each participating account gains units of value by achieving success within gaming events against other user accounts or by exchanging other assets (e.g., in-game currency, virtual items, or real-world currency) for these value-representing units. In some approaches, user accounts are given units of value by the digital gaming platform, (e.g., a host server or game publisher) as rewards for completing tasks or challenges, as a promotional incentive to attract new players, as compensation for participating in beta testing or providing feedback, or as part of a loyalty program or subscription service.

Continuing with the example depicted in FIG. 3, the first user account 300 makes first transfers 310, each dispensing 2 units of value to intermediary accounts labeled A, C, and E. Subsequently, the intermediary accounts engage in second transfers 330, where intermediary accounts A, C, and E each transfer 2 units to other intermediary accounts B, D, and F, respectively. Subsequently, accounts B, D, and F transfer 2 units of value to the second user account 340 via third transfers 350. While the example shown in FIG. 3 comprises a series of transfers having three sets of transfers 310, 330 and 350 each comprising three separate transfers, it is understood that the number of transfers in the series (and/or in each set) may vary according to the circumstance. Indeed, the number of transfers in each series may be 10s, 100s, 1000s or more, for example.

While each individual transfer in FIG. 3 involves only 2 units, a broader analysis reveals that the first user account experiences a net loss of 6 units, the second user account gains a total of 6 units, and the intermediary accounts A through F, neither gain nor lose value, as their inflow and outflow of units remain balanced.

In some embodiments of the disclosure, the digital gaming platform (e.g., 100) monitors transfer data, e.g., via processing circuitry 120 or 206, for transfers that exceed pre-defined thresholds. For example, a transfer threshold of 5 units may be applied, where a transfer of plus or minus 5 units would warrant processing circuitry (e.g., processing circuitry 120 or 206) to flag the transfer for further scrutiny or analysis. In some approaches, for the example depicted in FIG. 3, if a threshold were applied solely to individual transfers (e.g., a threshold of plus or minus 5 units), the transfers to and from the first and second user accounts would not trigger any flags. None of the individual transfers exceed the threshold.

In some examples, the digital gaming platform (e.g., 100) implements a variety of thresholds designed to monitor and analyze account activity. These thresholds may focus on individual transfer size (e.g., transfers exceeding 5 units), overall transfer amounts lost or gained by user accounts (e.g., 3 transfer gains totaling 10 units), the frequency of transfers within a specific period, sudden changes in an account's asset balance, the rapid inflow or outflow of assets (e.g., velocity), or transfers involving accounts with high-risk, suspect, or flagged origins or destinations. In some approaches, thresholds are game-specific, event-specific, and dynamically adjusted based on data analysis, player behavior trends, and the evolution transfer patterns over time.

In some embodiments of the disclosure, the first user account and the second user account collude to produce an unlikely transfer of value that circumvents the intended mechanics or violates the rules of the digital gaming environment. For example, this may occur through pre-arranged strategies during gameplay, where the first user account intentionally sacrifices resources or underperforms in a competitive event to ensure the second user account gains an unfair advantage. In some examples, the collusion occurs outside the gaming event, with the first user account transferring assets directly to the second user account under false pretenses or in a manner that disrupts the platform's intended economy e.g., within the digital gaming platform. Such unlikely transfers of value may undermine fair competition, harm the game's integrity, and potentially defraud other participating accounts.

In some approaches, any user account, including the intermediary accounts shown in FIG. 3, participate in a collusive scheme. For example, the colluding accounts might hold onto assets for longer than necessary, re-route transfers in unexpected ways, or coordinating with the first or second user accounts to achieve an illicit outcome.

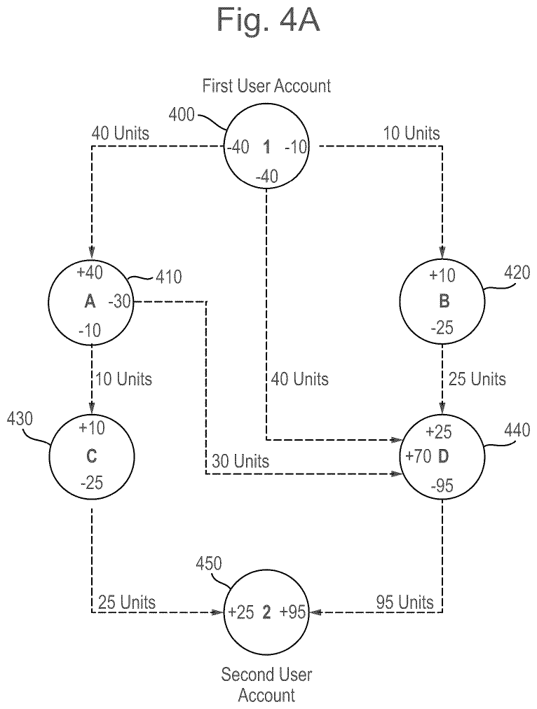

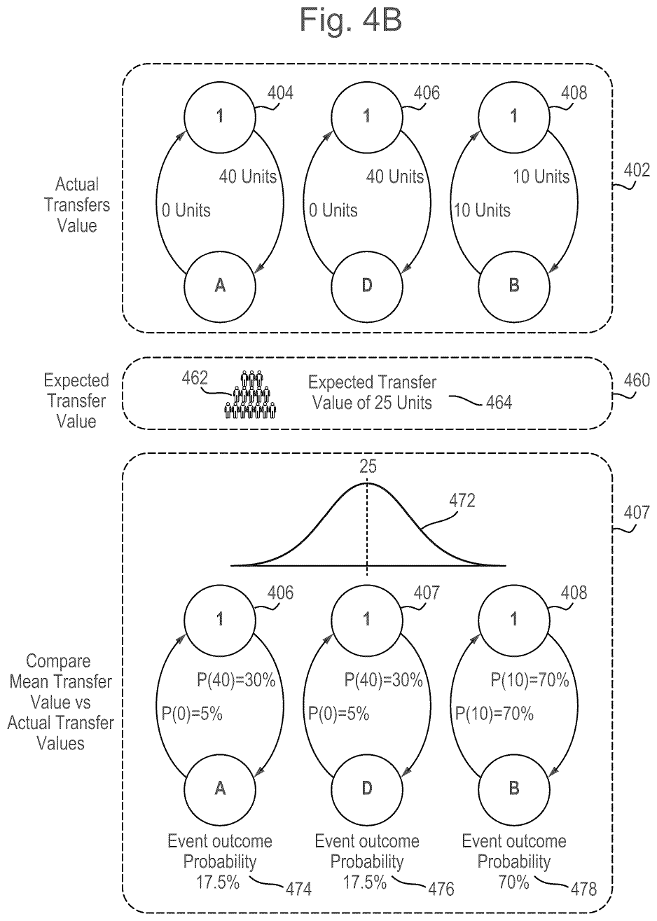

FIGS. 4A-4B illustrate example scenarios of collusion within a gaming event. FIG. 4A shows accounts (1, A, D, and 2) representing those accounts that are engaged in the collusive scheme, while accounts B and C are non-colluding. A first user account 400 (account 1) initiates the process by participating in three separate transfers, losing a total of 90 units: 40 to account A 410, 40 to account D 440, and 10 to account B 420. Accounts A and D, colluding with the first user account, then orchestrate a series of transfers to funnel most of the acquired value towards a second user account 450 (account 2). Account A 410 loses 30 units to D 440, and 10 units to non-colluding account C 430. Account B 420 loses 25 units to D 440, and account C 430 loses 25 units to account 2 450. Based on this, account D 440, loses 95 units to account 2. Ultimately, account 1 experiences a loss of 90 units, while account 2 gains a total of 120 units, the majority of which is a direct consequence of deliberate actions taken by colluding accounts to funnel as much value towards the second user account.

In some examples of the disclosure, each account interacts directly with another account, e.g., account 1 with account B. Such scenarios may take place in competitive gaming events involving 1:1 matches between two participating accounts, where both accounts place wagers. For instance, the first user account (400) may make a 20-unit wager, which is matched by non-colluding account B (420). In this exchange, account 1 accounts loses half of its wager, losing 10 units of value. However, in subsequent exchanges with colluding accounts A and D, the first user account wagers significantly more (40 units). In some embodiments, the first user account purposefully make larger wagers and subsequently loses to colluding accounts (e.g., A and D), effectively orchestrating a transfer of the majority of its initial value to the second user account 450.

In some examples, a digital gaming platform (e.g., 100 or 294) hosting a gaming event (e.g., 125), implements transfer thresholds. When these thresholds are exceeded, processing circuitry (e.g., 120 or 206) may be triggered to flag the offending transfers. For example, in the scenario depicted in FIG. 4A, if an individual transfer threshold of 50 units were applied, some of the transfers within the collusion scheme would be flagged (e.g., between accounts D and 2). In another example of the disclosure, a total transfer threshold of plus or minus 100 units is implemented, where any given account gaining or losing 100 units of value or more during any 1 gaming event may cause processing circuitry to trigger and flag the offending account and its transfers (e.g., account 2).

In some approaches, the digital gaming platform (e.g., 100 or 294) implements different thresholds to detect more nuanced patterns of value manipulation. For example, employing network flow algorithms (e.g., maximum flow) to analyze the flow of value between two nodes (e.g. two accounts), flagging deviations from expected patterns. Additionally, thresholds may be based on a participating account's historical transfer behavior, triggering alerts or flagging transfers when there are sudden, unusual spikes in activity. Digital gaming platforms might also establish dynamic thresholds based on the average transfers made during a specific gaming event, enabling them to identify outliers that warrant further investigation.

In some embodiments of the disclosure, a maximum flow algorithm is employed to analyze the flow of transfers within the gaming event (e.g., Ford-Fulkerson algorithm or Dinic's algorithm). Maximum flow algorithms may be used to calculate a maximum amount of flow, e.g., of units of value, that a system supports from a starting point to an end point. For instance, the processing circuitry (e.g., 120 or 206) may take the actual transfers made by participating accounts within a gaming event to be equivalent to the maximum flow between two nodes (e.g., user accounts).

In the context of the present disclosure, particularly referencing FIG. 4A, “maximum flow” specifically refers to the actual amount of units of value transferred between two accounts. For example, the maximum flow between account 1 and account A is 40 units. FIG. 4A represents the actual, measured transfers between these accounts, directly correlating to the movement of assets.

In an alternative example, the maximum flow along a path, e.g., of FIG. 4A, is limited by the lowest amount of value transferred between two accounts. For instance, in an example path including user accounts 1-A-C-2, the smallest transfer made is of a value 10 units between A and C. This limitation means that even though other segments of this path (e.g., 1-A or C-2) have higher transfer values, the overall flow reaching account 2 from account 1 cannot exceed 10 units.

FIG. 4B shows a method for calculating an expected transfer value 460, for a series of transfers between a first user account and a second user account, based at least in part on a first probability of an event outcome (e.g., depending on the specific rules and possible outcomes of the gaming event), and comparing the expected transfer value 460 with actual transfer values 402 of each transfer in the series of transfers between the first user account and the second user account. The example shown in FIG. 4B builds upon the example described in FIG. 4A. Specifically, FIG. 4A details three discrete transfers: 40 units transferred from the first user account to account A 404, 40 units to account D 406, and a transfer of 10 units lost and simultaneously gained in an interaction with account B 408.

At 460, in FIG. 4B, the processing circuitry (e.g., 120 or 206) calculates an expected transfer value. In some examples, historical transfer data 462, is used to calculate an expected average or mean transfer values e.g., a value which predicts most transfers. For instance, analysis of historical data 462 might reveal that a transfer outcome of either a loss of 25 units or a gain of 25 units per transfer is a common pattern.

In the context of this disclosure and in the example shown in FIG. 4B, an expected transfer value refers specifically to a mean value calculated from a probability distribution function. For example, at step 464, the expected transfer value might be calculated as 25 units, which represents the mean value calculated from the distribution of past transfers (e.g., probability distribution function 472 of past transfers 462).

In some examples, a likely range of transfer values distributed around the mean value is determined. For instance, the likely range could be set from 0 units to 50 units, including the most typical outcomes based on the observed historical data.

In some examples, the processing circuitry calculates the average outcome of past transfers. For example, the processing circuitry may analyze all transfers within a specific period, e.g., the last 12 months, to compute an average transfer value of 25 units per interaction.

In some examples, the processing calculates a standard deviation based on a population of past transfers. For example, after computing the average transfer value, the processing circuitry may determine the standard deviation to be 10 units. This measurement may indicate the extent to which individual transfers vary from the average, providing a statistical basis to evaluate the likelihood of a transfer being within a probabilistic range of outcomes.

In some examples, the processing circuitry uses percentile calculations to determine specific ranges within the historical data. For example, the processing circuitry may identify that 80% of past transfers fall within a range of −100 to +100 units.

In some examples, the processing circuitry employs a regression analysis. For example, the processing circuitry might analyze the relationship between the time of day and the size of transfers, discovering that larger transfers are more common during evening hours.

In some examples, the processing circuitry deploys machine learning algorithms to predict likely transfer values. For example, the processing circuitry could train a model on a dataset comprising various attributes of transfers, including the historical behavior of the accounts involved, event types, and outcomes.

In some examples, the processing circuitry uses moving averages, calculating the average transfer value over a specified number of recent transfers. For example, it may use a 30-day moving average to smooth out short-term fluctuations and highlight longer-term trends in transfer behavior.

In some examples, the processing circuitry uses a cluster analysis by grouping similar transfer patterns together. For example, the processing circuitry might identify clusters of accounts that frequently engage in small transfers, separate from those that periodically make large transfers.

At reference 407, the processing circuitry compares a probability of likely transfer values with the actual transfer values from the series of transfers between the first and second user accounts. In some examples, a standard deviation is derived from a distribution of past transfers 472. Specifically, the processing circuitry calculates the probability of each transfer within the series of transfers 406, 407, and 408, matching a certain range of values based on historical transfer data.

For example, the analysis might reveal that a loss of 40 units corresponds to a value range that historically includes 30% of historical transfers, a loss of 0 units corresponds to a value range that historically includes 5% of historical transfers, and a transfer resulting in a loss or gain of 10 units corresponds to a value range that historically includes 70% of all recorded transfers.

In some examples, the processing circuitry calculates probabilities for each transfer individually, e.g., for each loss or gain between two user accounts. In some examples, the processing circuitry calculates a probability for a series of transfers collectively, e.g., a total probability based on all transfers including both losses and gains, such as those occurring between accounts A, B, and D.

For example, at 474 and 476, the processing circuitry calculates a mean probability of 17.5% for transfers occurring between the first user account and accounts A and D. For transfers involving account B, the processing circuitry assigns a higher mean probability of 70%. In some examples, a low probability is flagged to indicate a deviation from an expected transfer value.

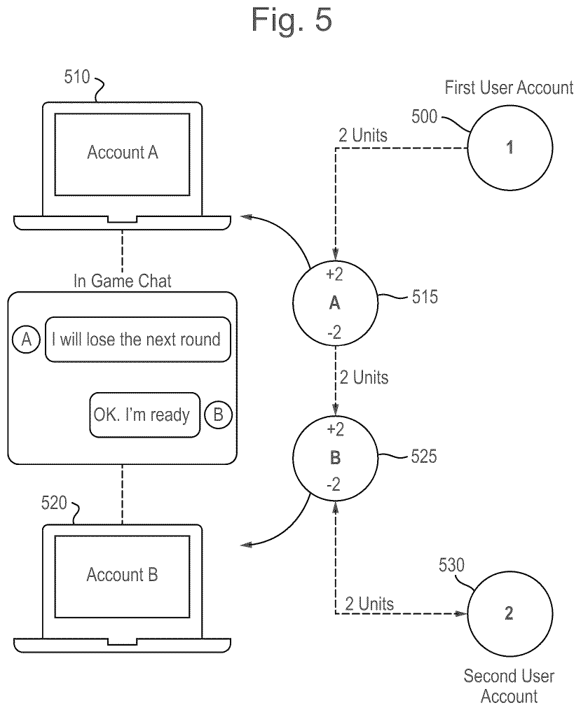

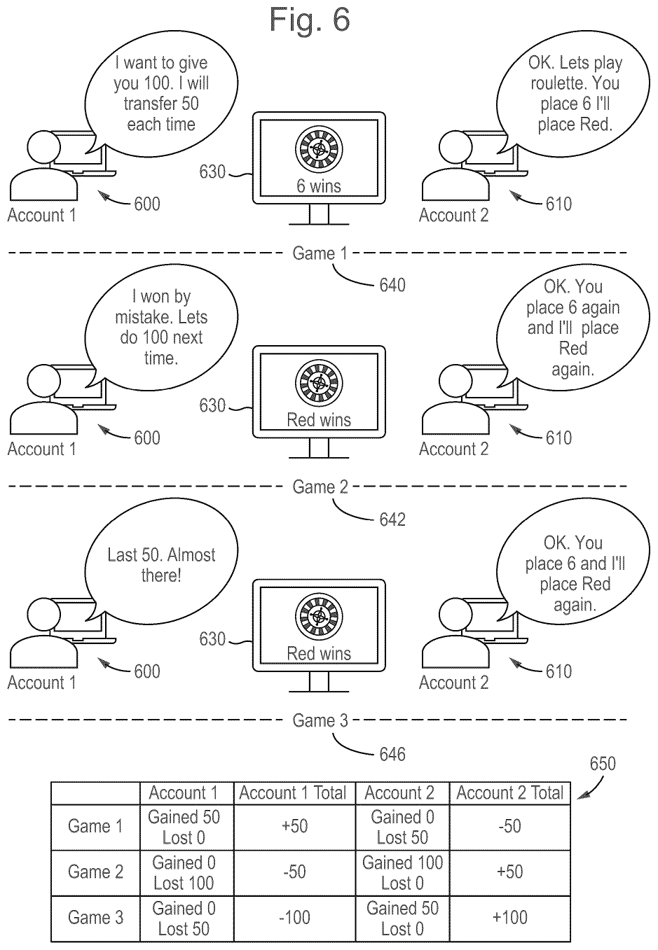

FIGS. 5 and 6 illustrate scenarios where two user accounts collaborate to execute a transfer, bypassing the typical competitive mechanisms of the gaming environment. In FIG. 5, a first user account 500 initiates a direct transfer, not linked to any gaming event, sending 2 units to account A 510.

In some examples, a user account is permitted by the digital gaming platform (e.g., 100 or 294) to execute a direct transfer to another user account. A direct transfer allows for the movement of units or assets between accounts without the necessity of a gaming event or competition to facilitate the transfer. Such functionality enables users to share resources, collaborate, or engage in transfers directly.

In some examples, the capability for user accounts to execute direct transfers, while intended to facilitate resource sharing and collaboration, can also be misused. User accounts may collaborate to strategically transfer assets from a first user account to a second user account through various means, including but not limited to direct transfers, intentionally losing at gaming events, or employing other mechanisms provided by the digital gaming platform. This misuse may undermine the fairness and competitive integrity of the gaming environment, as it allows for the manipulation of asset distribution and game outcomes beyond the scope of intended gameplay.

Following the initial direct transfer, account A 510 communicates with account B 520 through an in-game messaging system. A message sent from account A details an intention to deliberately lose in the upcoming round by stating, “I will lose the next round,” to which a message from account B responds, “OK. I'm ready.” Subsequently, account A intentionally loses 2 units 515 to account B, which correspondingly gains 2 units 525. Account B executes a direct transfer of the 2 units to a second user account 530, effectively completing the collaborative transfer process from a first user account to a second user account.

In some examples, user accounts utilize a variety of communication channels to collaborate. For example, user accounts may use voice communication allow to discuss strategies or intentions. In another example, user accounts users accounts may employ in-game actions or signals (e.g., performing specific in-game actions in a pattern) as a form of covert communication.

In the example depicted in FIG. 6, a first user account 600 competes in a first game 640 against a second user account 610. Prior to the gaming event 630, the two accounts establish communication through a voice channel. During this exchange, account 1 600 communicates the intention to transfer a total of 100 units to account 2 610, planning to split the transfer into two equal parts of 50 units each. However, the outcome diverges from the initial plan, with account 1 600 unintentionally winning the round, resulting in a gain of 50 units, contrary to the intended transfer to account 2 610, which consequently loses 50 units.

In some examples, the strategies employed by colluding accounts incorporate an element of chance, blending deliberate actions with the inherent unpredictability of gaming outcomes (e.g. betting outcomes). Even when accounts set out to execute a planned transfer of assets or to influence the outcome of a gaming event in a specific way, the unpredictable nature of the game itself can lead to unexpected results.

Continuing with the example shown in FIG. 6, to rectify the unintended outcome of the initial game, a strategy is adopted through account 1 to double the stakes in the subsequent game 642, thereby increasing the potential transfer to 100 units. In this game, the transfer takes place as intended, with account 1 deliberately losing, resulting in a complete transfer of the 100 units staked on the game to account 2. This compensates for the earlier miscalculation and aligns with the original intent to transfer a total of 100 units. Following this correction, a third game 646 is played, with account 1 losing the game and thus transferring the final 50 units to account 2. Through these adjusted strategies across three games, account 1 effectively transfers the intended total of 100 units to account 2.

In some examples, participants engage in gaming events directly against the gaming platform, known as “the house,” rather than competing against each other. The house may act as the central counterparty for all transfers (e.g., bets). Unlike peer-to-peer scenarios, where outcomes are influenced by individual strategies, playing against the house involves fixed odds and rules controlled by the gaming platform.

In some examples, where participants compete directly against the gaming platform or “the house,” processing circuitry 120 or 206, monitors a sequence of repeated transfers made by participating accounts. Processing circuitry may identify irregular betting practices that may indicate potential fraud or manipulation. For example, in scenarios depicted in gaming environments, such as in FIG. 6, processing circuitry monitors accounts that engage in a series of consistent transfer behaviours 650, such as placing the same bets repeatedly, regardless of the outcomes. Such patterns, especially when they deviate from expected betting norms given the fixed odds and rules set by the house, can signal potential collusion or other forms of deceptive practices within the gaming platform.

For example, in the depicted scenario of FIG. 6, account 1 adopts a betting strategy characterized by consistently low odds of success (e.g., betting on “6”), while account 2 selects options with a higher probability of winning (e.g., betting on “red”). This pattern of betting, where both accounts engage in strategically divergent but predictable bets over multiple rounds, suggests a potential collusive tactic or an attempt to manipulate the outcome for a predetermined arrangement between the participating accounts.

In some examples participants manipulate bets by choosing mutually exclusive and collectively exhaustive (MECE) outcomes to ensure a predetermined transfer of funds. This approach predicts that regardless of the game's result, one party will win and the other will lose, facilitating a controlled flow of value under the guise of legitimate transfers. The introduction of an element of chance, however, may disrupt these planned transfers if an unexpected outcome materializes, such as the initial result of game 1 640 in FIG. 6.

In some examples, the expected transfer value between two accounts takes into account the probabilities of competing outcomes and the amount of value attributed to a given transfer. For an event X with a probability p(X), where p(X)>0.5p, indicating a higher likelihood of occurrence, the expected transfer, denoted as M, is calculated as:

$$M = ( Profit 1 - Stake 2 ) \times p ( X ) - ( Profit 2 - Stake 1 ) \times p ( 1 - X )$$

Here, Profit1 and Profit2 represent the potential gains for the first and second accounts if their respective favored outcomes occur, while Stake1 and Stake2 are the amounts at risk by each participating account. This calculation provides an estimation of the net value expected to change hands between two accounts (e.g., bettors) based on their stake (e.g., bets) and the likelihoods of the respective outcomes.

In some examples, the digital gaming platform e.g., 100 or 294, utilizes processing circuitry 120 or 206, to detect patterns of transfers between user accounts involving a series of gaming events. For example, the processing circuitry may compare the probability of event outcomes for each transfer in the sequence, such as those occurring in game 1, game 2, and game 3. By analyzing the likelihood of these outcomes based on historical data and expected gameplay behavior, the processing circuitry may identify anomalies that may indicate collusive activity.

In some examples, processing circuitry 120 or 206, identifies collusion by searching for significant fluctuations in transfer probabilities between two user accounts. For instance, if during a sequence of games (e.g., games 1, 2 and 3 in FIG. 6), the processing circuitry observes that the probability of a user account losing a game shifts dramatically without a corresponding change in gameplay skill or strategy, this could indicate collusive behavior. For example, after an unexpected win in the first game, the subsequent action by one account to double the stakes and then lose a larger amount in the next game does not align with typical competitive behavior.

In some examples, processing circuitry 120 or 206, analyzes transfer data to detect repetitive actions indicative of a user account deviating from expected norms. For instance, if a user account is consistently flagged for actions that significantly deviate from established behavioral patterns, such as repeatedly engaging in transfers that diverge from the probabilistic outcomes anticipated based on historical gameplay data.

In some examples, multiple digital gaming platforms, such as 100 or 294, communicate within a digital gaming environment through a communication network, such as network 290, to collaborate in identifying user accounts that are engaging in collusion. For instance, by sharing data and analytics across platforms, a comprehensive profile of user behavior may be constructed, allowing for the detection of patterns that suggest collusion.

In some examples, multiple gaming platforms e.g., 100 or 294 communicate transfer data to a centralized processing system (e.g., as depicted in FIG. 8A), which comprises processing circuitry and a database designed to store and analyze the data from various sources.

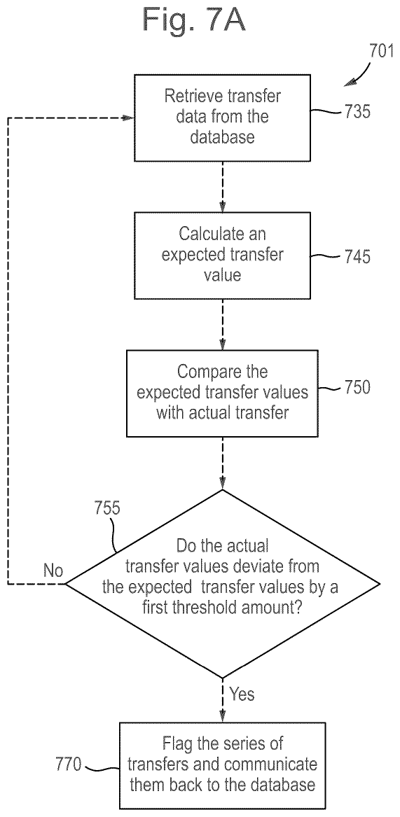

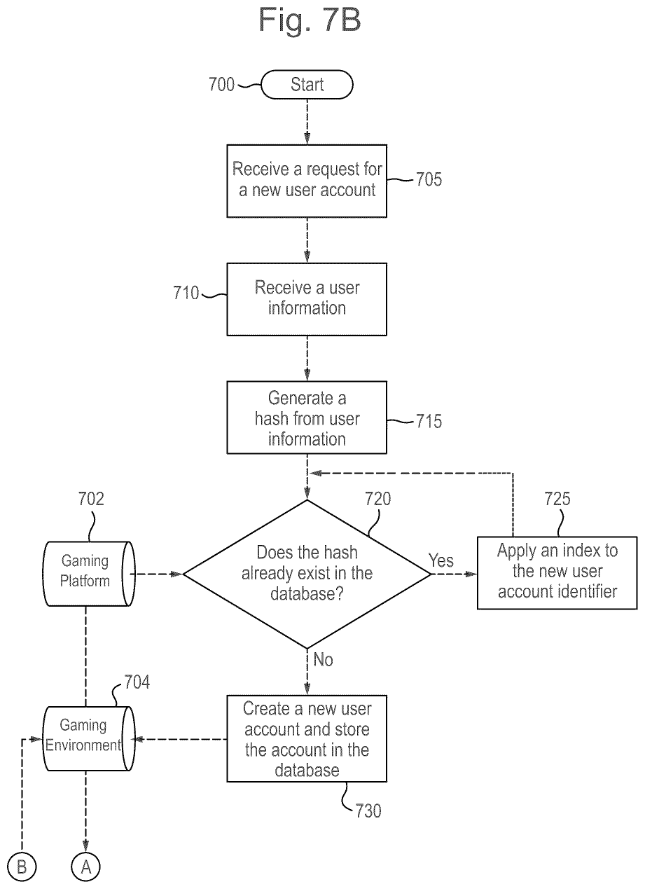

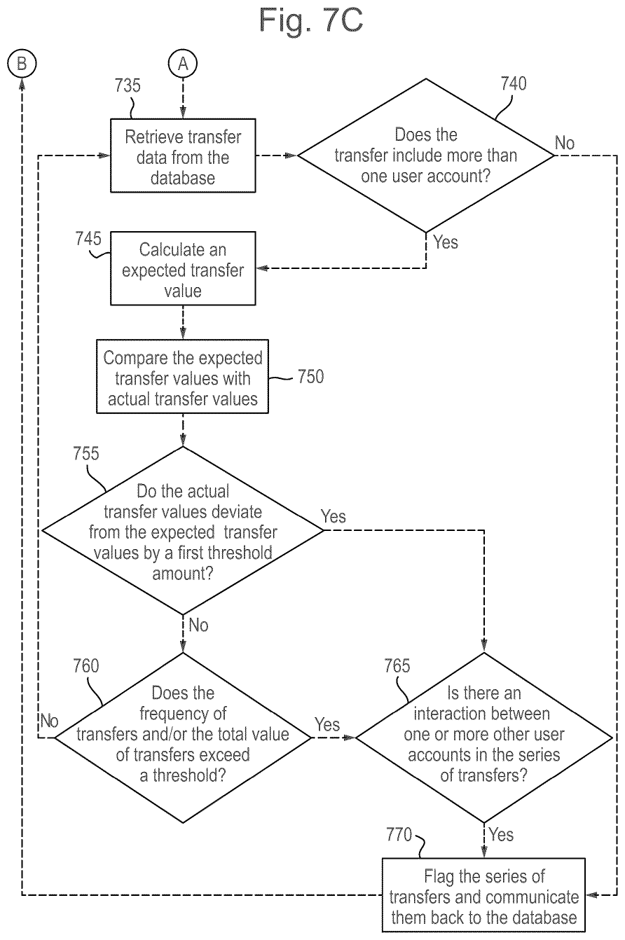

FIG. 7A illustrates a flowchart that depicts process 701 for analyzing transfer data (e.g. 115) within a digital gaming environment, leveraging the infrastructure outlined in FIGS. 2A and 2B. The process begins at step 735, where the processing circuitry (e.g., 120 or 206) retrieves transfer data from a database, e.g., database 110, 208, 287, or 295. These databases are described in FIGS. 2A and 2B, serving as repositories for storing transfer data and other relevant information within the gaming environment. In some examples, transfer data is between any two nodes within the network, irrespective of their direct participation in a specific gaming event.

At step 745, the processing circuitry calculates an expected transfer value, e.g., a mean transfer value derived from a probability function such as in. This calculation may involve analyzing historical transfer data to predict the likely outcome of a transfer, employing algorithms that may reside within the control circuitry 204 or processing circuitry 206 of the devices outlined in FIGS. 2A and 2B.

At step 750, the processing circuitry compares the expected transfer value (e.g., a mean value) with the actual transfer values observed in transfers depicted in FIGS. 1, 3, 4A, 4B, 5, and 6. At step 755, the processing circuitry evaluates whether the deviation between the actual values and the expected transfer value exceeds a threshold, e.g., 50 units.

If the deviation exceeds the threshold, the process moves to step 770, where the processing circuitry flags the series of transfers and communicates these findings back to the database. This action may involve tagging the transfers with specific metadata that highlights the anomaly for further investigation or monitoring.

If there is no deviation exceeding a threshold, the processing circuitry continues its monitoring activities, returning to step 735 to retrieve and analyze new transfer data from the database.

FIGS. 7B and 7C expand upon the analytical framework established in FIG. 7A by introducing a process for creating a new user account within the digital gaming environment, illustrating how these operations integrate with the systems and devices described in FIGS. 2A and 2B. FIGS. 7B and 7C detail process 700 for creating a new user account (e.g., in response to a request at a digital gaming platform 100 or 294 detailed further in FIGS. 8B and 8C.

In some examples, the process depicted in FIG. 7B begins at 705 with the digital gaming platform (e.g., 100 or 294) receiving a request for a new user account e.g., via I/O path 282. At step 710, the processing circuitry, e.g., 102 or 206, receives user information, such as a social security number, via a communication path, e.g., the communication network 290 from a user input at a user device (e.g., user equipment 270, 280 or 275). The described system incorporates a network which reflects the connectivity infrastructure detailed in FIGS. 2A and 2B, where devices and servers are interconnected to support data operations within the gaming environment.

In some examples, following the receipt of user information, at step 715, the processing circuitry (e.g., 120 or 206) generates a unique user identifier using the user information (e.g., hashing the social security number), a process that is further detailed in FIGS. 8B and 8C. The identifier may serve as a tool for distinguishing individual users within the digital gaming environment across different digital gaming platforms. At step 720, the processing circuitry assesses whether the unique identifier already exists within the database (e.g., databases 110, 208, 287, or 295), ensuring that each user account is distinct.

In some examples, if the identifier is found to be pre-existing, the process advances to step 725, where the processing circuitry (e.g., 120 or 206) assigns an index to the new user account identifier to maintain uniqueness, subsequently creating and storing the new account in the database at step 730. Should the identifier be new, the processing circuitry proceeds to step 730 without the need for indexing.

In some examples, the processing circuitry, e.g., 120 or 206, is configured to access and search within the storage of the digital gaming platform, e.g., 702 or 295. The processing circuitry may be part of a broader ecosystem that encompasses multiple digital gaming platforms, collectively forming a digital gaming environment.

In some examples, following the creation and storage of a new user account within the digital gaming environment, as outlined in FIG. 7B, the processing circuitry (e.g., 120 or 206) takes further steps to integrate this account into the broader gaming ecosystem. For example, the processing circuitry updates the database of the digital gaming platform, e.g., 295, with details of the new user account. In some examples, a distributed ledger is updated to databases of the digital gaming environment.

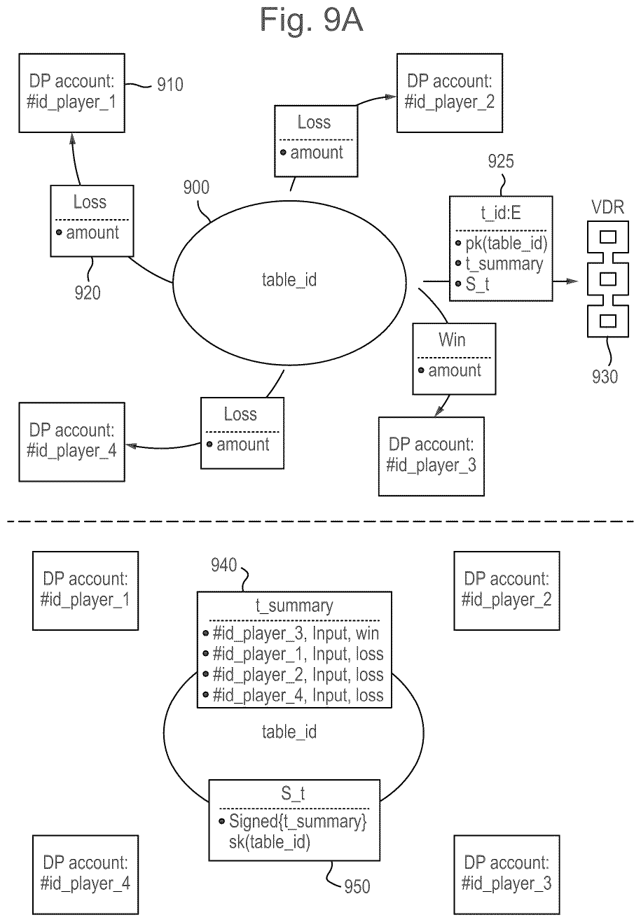

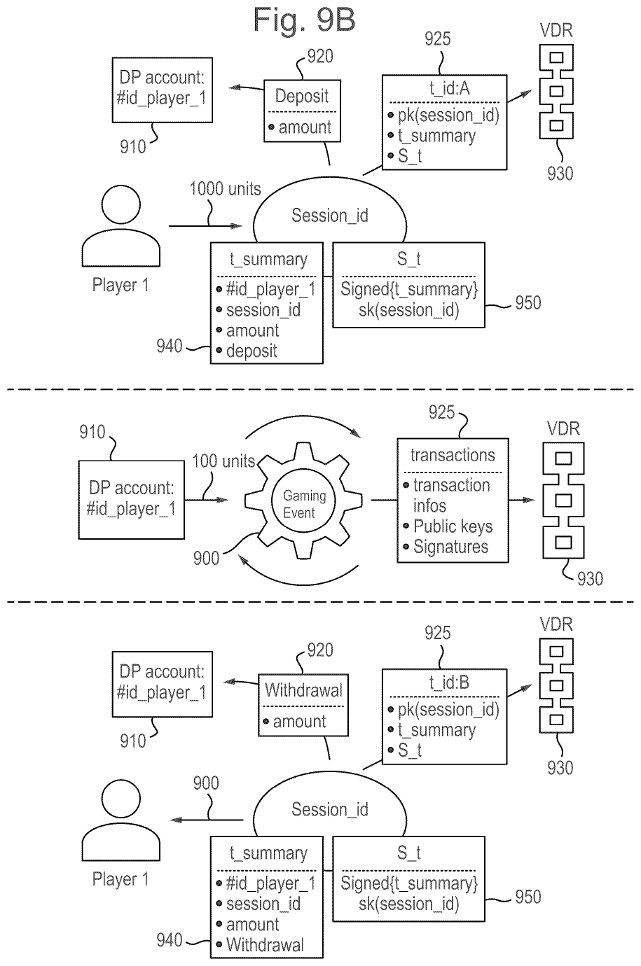

FIG. 7C extends the analytical process described in FIG. 7A by introducing additional decision-making steps that refine how the processing circuitry handles transfer data. In some examples, at step 740, the processing circuitry assesses the retrieved transfer data to determine if transfers involve more than one user account (detailed further in FIG. 9B). If the transfer data pertains to transfers involving a single account, such activities are flagged at step 770 and the relevant information is communicated back to the database for further analysis or action.

In some examples, when evaluating transfer values at step 755, if the processing circuitry (e.g., 120 or 206) identifies a deviation from likely transfer values that exceeds a specified threshold, it then proceeds to step 765. Here, the processing circuitry assesses whether there is any interaction among one or more other user accounts within the series of transfers (as described in FIGS. 5 and 6). Interactions that suggest collusion or irregular transfer patterns are flagged at step 770.

In some examples, if the deviation does not exceed the first threshold, the processing circuitry moves to step 760, where it evaluates the frequency of transfers and/or the total value of transfers against another set threshold. Transfers that surpass this threshold indicate potential misuse or abnormal activity, prompting the processing circuitry to flag these transfers at step 770. In some examples, if no thresholds are exceeded, the process loops back to step 735, indicating the processing circuitry's continuous monitoring and analysis cycle within the gaming environment.

FIG. 8A presents an overview of a digital gaming environment, where system 800 operates as the central node. In some examples, system 800 comprises processing circuitry (e.g., 120 or 206) and a database (e.g., 110 or 295). System 800 may be configured to be communicatively linked to various digital gaming platforms 810 e.g., through a communication path (290), facilitating an exchange of data. For example, system 800 may send and receive data 820 (e.g., transfer data).

In some examples, a new user account (detailed in FIGS. 8B and 8C) is be requested at a digital gaming platform 810. The digital gaming platform may update system 800 (e.g., database 295) about new user accounts.

In some examples, the digital gaming environment is configured as a blockchain enabled network. For example, system 800, alongside digital gaming platforms 810, are utilized to collaboratively update and store information regarding user accounts and their transfer activities within the digital gaming environment. In some examples, each platform acts as a node within the blockchain, contributing to the maintenance of a distributed ledger. The distributed leger may contain records of user accounts and their transfers. In some examples, each node collects transfer data, and then distributes the transfer data to other nodes for validation and addition to the blockchain.

FIGS. 8B and 8C detail the systems and processes involved in creating and managing user accounts within a digital gaming environment. A user device 830 (e.g., such as user equipment depicted in FIGS. 2A and 2B) requests a new user account from digital gaming platform 810 (e.g., 110 or 294). For example, a user device may use built-in capabilities, such as networking interfaces, processors, and input/output circuitry, to communicate with the digital gaming platform over established networks. For example, a smartphone (as depicted in FIG. 2A) or a gaming console (referenced in FIG. 2B) may use an application or web interface to submit user information such as a preferred username, password, and additional verification details, like an email address or phone number, to the platform.

Digital gaming platform 810 receives user information 835 e.g., via communication network 290 and I/O path 282. In some examples, the digital gaming platform 810, requests additional verification by requesting a unique identifier as part of the account creation process. For instance, alongside standard registration details, the platform may require a social security number as a form of unique identification.

Control circuitry (e.g., 204) and/or processing circuitry (e.g., 120 or 206) of the digital gaming platform receives up to date information pertaining to user accounts stored across the digital gaming environment via a database of system 800 (e.g., as shown in FIG. 8A). In some examples, the database associated with system 800 serves as a central repository for storing comprehensive data related to user accounts across the digital gaming environment. The digital gaming platform, through control circuitry (for example, 204) or processing circuitry (for instance, 120 or 206), accesses this database to retrieve the latest information about user accounts.

At 840, processing circuitry (e.g., 120 or 206) applies a hashing function to the user information (e.g., using a deterministic algorithm) which is also encrypted (e.g., using an encryption technique) and stored at 855 using the generated unique identifier as address.

At 860, the processing circuitry checks if the hash based unique identifier (e.g., the hashed social security number) already exists by searching the database of system 800. If yes, at 865, user information is compared to an encrypted version found in the database (e.g. the un-hashed SSN is compared to an encrypted SSN found in the database corresponding to the matching hash value).

User information is encrypted using a stored public key also found from the same location. If the subsequent values are not equal (e.g., the SSNs do not match), a collision event is detected (e.g., two different SSNs have led to the same hash value). The collision is handled by applying an index at 870, to the hash based unique identifier. This process is repeated until no matches are found or matching encrypted user information is found in the database. If the encrypted values are equal (e.g., SSN values match), the account already exists in the database (e.g., of another digital platform) no collision is detected, and the record may be updated in the database of system 800 which in turn updates the digital gaming platform 810. At 860, if no matching hash value was detected, then the processing circuitry creates a new account which is stored in the digital gaming platform 810 which in turn updates the stored account information of system 800.

In some examples, processing circuitry 120 or 206 updates system 800 and digital gaming platform 810 either simultaneously or separately, in any order, according to the requirements of the digital gaming environment. In some examples, the hashing process involves transforming the input user information a hash value using a deterministic algorithm. The hashing algorithm ensures that the same input will always produce the same output hash.

FIG. 8C illustrates a creation of a new user account in accordance with some embodiments of the disclosure. A digital gaming platform 810, receives a user input 832 via a user device 830. The digital gaming platform 810 receives an SSN (e.g., from user information 825) as part of request to create a new user account. The SSN is shown as SSN-X. In some examples, a hash function is employed to generate a unique identifier based on a Social Security Number SSN.

In some examples, a dynamic hash table is employed within System 800. This hash table is equipped to handle collisions (e.g., when two hash-based unique identifiers appear to be identical) by assigning an additional digit to the hash value, creating a unique index number. For instance, if the hash of SSN_X is represented as a 6-digit integer (e.g., #{SSN_X}=123456), a collision may be resolved by appending a seventh digit, resulting in a value such as #{SSN_X}∥1=1234561, where “∥” denotes concatenation.

In some examples, following the hashing step, the user identity information (e.g., social security number) undergoes encryption 850 via an encryption algorithm. The encrypted information, represented for example as {SSN_X}pk, utilizes a public key (pk) for encryption. The use of public key cryptography implies that decryption can only be achieved with the corresponding private key, which may reinforce the security of the identifier. In some examples, only public keys (“pk”, the keys that enable encryption) are stored in the dynamic hash-table, and private keys (the keys that enable decryption) are kept secret by each Digital Platform (DP). As a result, the only entity possessing a private key for specific encrypted user information is the DP that originally stored that encrypted value in the dynamic hash-table.

In some examples, the encrypted user identity information is stored in the database of system 800 (e.g., a hash table 855). In some examples, the digital gaming platform (e.g., DP_0) and the system database are communicatively linked and are configured to update each other (e.g., via a distributed ledger containing the hash table) whenever there is a change.

In some examples, In the implementation of distributed ledger technologies DLT, within the digital gaming environment, the hash table becomes a decentralized entity, propagated across digital gaming platforms within the digital gaming environment. The integrity and consistency of this hash table are upheld through an established consensus policy, ensuring that all participants have a synchronized version of the data.

For example, within the digital gaming environment, the consensus policy stipulates that a new block 855 containing the encrypted user identity information must be verified and accepted by a majority of the nodes (digital gaming platforms) before new address is appended (with aforementioned block) to the distributed ledger. If a hash collision is detected, the policy might require that the smart contract facility trigger a collision resolution mechanism, e.g., appending an index to create a unique identifier, which must then be ratified by the nodes according to the policy's rules.

FIGS. 9A to 9B present example scenarios illustrating different types of transfer activity, in accordance with some examples of the disclosure. FIG. 9A shows an example illustration of a gaming event and the corresponding transfer data. In some examples, each participating account 910, is assigned a unique identifier displayed as ‘#id_player_i’, with ‘i’ being an index used to differentiate between multiple players. This identifier may be created following the processes set out during registration. For example, an account may participate in a gaming event 900, contributing an amount of value and a corresponding result 920 (e.g., a loss or win of 50 units). In some examples, a summary of the transfers and participating accounts 925 is sent to a verifiable data register VDR 930 (e.g., database 110 or 294).

FIGS. 9A to 9B present example scenarios illustrating different types of transfer activity, in accordance with some examples of the disclosure. FIG. 9A shows an example illustration of a gaming event and the corresponding transfer data. In some examples, each participating account 910, is assigned a unique identifier displayed as ‘#id_player_i’, with ‘i’ being an index used to differentiate between multiple players. This identifier may be created following the processes set out during registration. For example, an account may participate in a gaming event 900, contributing an amount of value and a corresponding result 920 (e.g., a loss or win of 50 units). In some examples, a summary of the transfers and participating accounts 925 is sent to a verifiable data register VDR 930 (e.g., database 110 or 294). In some examples, the summary of the transfers 925 includes a summary of wins and losses 940 and a cryptographic signature 950 (e.g., a unique id attributed to the gaming event).

In some examples, the transfer id (t_id), serves as a unique reference for that particular transfer. In some examples, transfer data (e.g., 115) may include a unique identifier of a participating account (#id_player_i), the identifier for the table or gaming event (table_id), the amount of assets which are being inputted (amount), and the resulting type of transfer (loss or win), as depicted in FIG. 9A.

FIG. 9B illustrates an example transfer scenario within a digital gaming environment. In the depicted example in FIG. 9B, a deposit of assets (e.g., 1000 units) is made into an account 910 (e.g., account 1). The account participates in a gaming event 900 in which a small amount is lost (e.g., 100 units). A small amount may be any amount less than a threshold which, in the context of FIG. 9B, may be set based on the digital gaming platform's policies or the specific game's rules. For instance, if the threshold is defined as 200 units, a loss of 100 units could be considered a small amount.

In some examples, upon initiating the deposit, a summary of the transfer 925 is generated. This summary may detail the amount deposited by the account and any additional metadata, such as the payment method used for the deposit. As depicted in previous FIG. 9A, the transfer summary may be signed with a session's secret key (sk{table_id}) 950. In some examples, the transfer summary is transmitted to the local VDR 930.

In some examples, after participation in the gaming event 900, a majority of those assets are subsequently withdrawn (e.g. 900 units) and deposited back into the account 910. In some examples, processing circuitry 120 or 206, analyze transfer data (e.g., comprising data 925 stored in a VDR 930) to identify distinctive patterns and activities indicative of specific behaviors within the digital gaming environment. For example, account 910 engages in gaming event 900 and experiences a loss, the processing circuitry may evaluate the follow-up action where a majority of assets input from the account, e.g., 900 units, is re-deposited into the account.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

1. A system for analyzing transfer data in a digital gaming environment, comprising:
a database configured to store transfer data associated with user accounts of the digital gaming environment; and
processing circuitry configured to:
retrieve transfer data from the database, wherein the transfer data comprises data relating to a series of transfers between a first user account and a second user account;
calculate an expected transfer value of the series of transfers between the first user account and the second user account, wherein calculating the expected transfer value is based on a first probability of an event outcome in the digital gaming environment;
compare the expected transfer value with an actual transfer value of each transfer in the series of transfers between the first user account and the second user account; and
upon determining that the actual transfer value deviates from the expected transfer value by a first threshold amount, flag the series of transfers and communicate the flagged series of transfers between the first user account and the second user account back to the database.

2. The system of claim 1, wherein the processing circuitry is configured to:
retrieve transfer data from the database, wherein the transfer data comprises a series of transfers between the first user account and the second user account via one or more other user accounts;
calculate an expected transfer value between each pair of user accounts in the series of transfers, based on a second probability of an event outcome in the digital gaming environment;
compare the expected transfer value with actual transfer values of the series of transfers occurring between the first user account and the second user account; and
upon determining the actual transfer values deviate from the expected transfer value by a second threshold amount, flag the series of transfers and communicate details of the first user account and the second user account back to the database.

3. The system of claim 2, wherein the processing circuitry is configured to:
in response to determining that the actual transfer values deviate from the expected transfer value by the second threshold amount, identify an interaction between the one or more other user accounts in the series of transfers; and
in response to identifying the interaction, communicate details of the interaction back to the database.

4. The system of claim 1, wherein the processing circuitry is configured to determine the first probability by:
determining, within the series of transfers between the first user account and the second user account a second probability of a transfer gain of the first user account minus a transfer loss of the second user account, and a third probability of a transfer gain of the second user account minus a transfer loss of the first user account;
calculating the first probability based on the second and third probabilities; and
adjusting the expected transfer value based on the first probability.

5. The system of claim 1, wherein the processing circuitry is configured to:
identify a transfer within the transfer data where the transfer consists only of the first user account, wherein the transfer occurs into and subsequently out of the first user account without any participation in an event associated with the digital gaming environment; and
in response to identifying the transfer, communicate details of the transfer and the first user account back to the database.

6. The system of claim 1, wherein the processing circuitry is further configured to:
communicate details of the flagged series of transfers, the first user account, and the second user account to one or more other databases associated with the digital gaming environment.

7. The system of claim 1, wherein the processing circuitry is configured to:
calculate at least one of:
a frequency of transfers within a time period for the series of transfers between the first user account and the second user account; or
a total value of transfers within the time period for the series of transfers between the first user account and the second user account; and
in response to at least one of the frequency of transfers or the total value of transfers exceeding a respective threshold, flag the series of transfers and communicate details of the first user account and the second user account back to the database.

8. The system of claim 1, wherein the processing circuitry is configured to:
upon receiving user information for the first user account within the digital gaming environment, perform a hashing process on the user information to generate a hash-based identifier;
encrypt the user information to produce an encrypted identifier;
determine if the hash-based identifier exists in the database; and
in response to determining that the hash-based identifier does not exist in the database, store the encrypted identifier in the database for the first user account.

9. The system of claim 8, wherein the processing circuitry is further configured to:
upon determining that the hash-based identifier does exist in the database, modify the hash-based identifier by concatenating it with an index to produce an indexed hash-based identifier.

10. The system of claim 8, wherein the processing circuitry is further configured to:
compare the user information between the first user account and the second user account, wherein the user information comprises multiple forms of identification;
determine if a threshold number of the multiple forms of identification matches between the first user account and the second user account; and
in response to determining that the threshold number of the multiple forms of identification matches, communicate details of the first user account and the second user account back to the database.

11. A method for analyzing transfer data in a digital environment comprising:
retrieving transfer data from a database configured to store transfer data associated with user accounts of the digital environment, wherein the transfer data comprises data relating to a series of transfers between a first user account and a second user account;
calculating an expected transfer value the series of transfers between the first user account and the second user account, wherein calculating the expected transfer value is based on a first probability of an event outcome in the digital environment;
comparing the expected transfer value with an actual transfer value of each transfer in the series of transfers between the first user account and the second user account; and
upon determining that the actual transfer value deviates from the expected transfer value by a first threshold amount, flagging the series of transfers and communicate the flagged series of transfers between the first user account and the second user account back to the database.

12. The method of claim 11, further comprising:
retrieving transfer data from the database, wherein the transfer data comprises a series of transfers between the first user account and the second user account via one or more other user accounts;
calculating an expected transfer value between each pair of user accounts in the series of transfers, based on a second probability of an event outcome in the digital environment;
comparing the expected transfer value with actual transfer values of the series of transfers occurring between the first user account and the second user account; and
upon determining the actual transfer values deviate from the expected transfer value by a second threshold amount, flagging the series of transfers and communicating details of the first user account and the second user account back to the database.

13. The method of claim 12, wherein the processing circuitry is configured to:
in response to determining that the actual transfer values deviate from the expected transfer value by the second threshold amount, identifying an interaction between the one or more other user accounts in the series of transfers; and
in response to identifying the interaction, communicating details of the interaction back to the database.

14. The method of claim 11, wherein determining the first probability comprises:
determining, within the series of transfers between the first user account and the second user account a second probability of a transfer gain of the first user account minus a transfer loss of the second user account, and a third probability of a transfer gain of the second user account minus a transfer loss of the first user account;
calculating the first probability based on the second and third probabilities; and
adjusting the expected transfer value based on the first probability.

15. The method of claim 11, further comprising:
identifying a transfer within the transfer data where the transfer consists only of the first user account, wherein the transfer occurs into and subsequently out of the first user account without any participation in an event associated with the digital environment; and
in response to identifying the transfer, communicating details of the transfer and the first user account back to the database.

16. The method of claim 11, further comprising:
communicating details of the flagged series of transfers, the first user account, and the second user account to one or more other databases associated with the digital environment.

17. The method of claim 11, further comprising
calculating at least one of:
a frequency of transfers within a time period for the series of transfers between the first user account and the second user account; or
a total value of transfers within the time period for the series of transfers between the first user account and the second user account; and
in response to at least one of the frequency of transfers or the total value of transfers exceeding a respective threshold, flagging the series of transfers and communicate details of the first user account and the second user account back to the database.

18. The method of claim 11, further comprising:
upon receiving user information for the first user account within the digital environment, performing a hashing process on the user information to generate a hash-based identifier;
encrypting the user information to produce an encrypted identifier;
determining if the hash-based identifier exists in the database; and
in response to determining that the hash-based identifier does not exist in the database, storing the encrypted identifier in the database for the first user account.

19. The method of claim 18, further comprising:
upon determining that the hash-based identifier does exist in the database, modifying the hash-based identifier by concatenating it with an index to produce an indexed hash-based identifier.

20. The method of claim 18, further comprising:
comparing the user information between the first user account and the second user account, wherein the user information comprises multiple forms of identification;
determining if a threshold number of the multiple forms of identification matches between the first user account and the second user account; and
in response to determining that the threshold number of the multiple forms of identification matches, communicating details of the first user account and the second user account back to the database.

21.-50. (canceled)
